(19) United States
(12) Patent Application Publication
(10) Pub. No.: US 2014/0289477 A1
(43) Pub. Date: Sep. 25, 2014

(54) LIGHTWEIGHT PRIMARY CACHE REPLACEMENT SCHEME USING ASSOCIATED CACHE

(71) Applicant: INTERNATIONAL BUSINESS MACHINES CORPORATION, Armonk, NY (US)

(72) Inventors: Bulent Abali, Tenafly, NJ (US); Mohammad Banikazemi, New York, NY (US); Parijat Dube, Hicksville, NY (US)

(73) Assignee: International Business Machines Corporation, Armonk, NY (US)

(21) Appl. No.: 13/891,541

(22) Filed: May 10, 2013

Related U.S. Application Data
(63) Continuation of application No. 13/849,775, filed on Mar. 25, 2013.

(51) Int. Cl. G06F 12/08

(52) U.S. Cl. CPC G06F 12/0891
USPC 711/136; 711/133

(57) ABSTRACT

One aspect provides an apparatus including: at least one processor; and a computer readable storage medium having computer readable program code embodied therewith and executable by the at least one processor, the computer readable program code including: computer readable program code configured to, responsive to a request for data and a miss in both a first cache and a second cache, retrieve the data from memory, the first cache storing at least a subset of data stored in the second cache; computer readable program code configured to infer from information available from the first cache a replacement entry in the second cache; and computer readable program code configured to, responsive to inferring from information available from the first cache a replacement entry in the second cache, replace an entry in the second cache with the data from memory. Other aspects are described and claimed.

### CROSS REFERENCE TO RELATED APPLICATION

This application is a continuation of U.S. patent application Ser. No. 13/849,775, entitled “LIGHTWEIGHT PRIMARY CACHE REPLACEMENT SCHEME USING ASSOCIATED CACHE”, filed on Mar. 25, 2013, the contents of which are fully incorporated by reference herein.

### BACKGROUND

The subject matter described herein generally relates to techniques for cache line replacement in a computer or other information handling device (e.g., workstation computer, desktop computer, laptop computer, or the like) memory system.

A cache is a memory element or device used for storage of a subset of information contained in another, larger memory device. Caches are employed, e.g., to reduce latency, as in the case of storing frequently used data for quicker access. Thus, a cache allows quicker access to needed data. Caches implement replacement policies due to their limited size. For example, on inserting a new entry into a full cache, another entry is removed. A cache replacement policy governs this process. A variety of cache replacement policies are known.

Advances in memory technology have led to the use of memory subsystems that have increased storage capacity, i.e., are larger but slower than DRAM. These increased capacity memory systems include for example so called “hybrid” memory subsystems. An attendant result of such increased capacity memory subsystems has been the introduction of another level of cache into the memory hierarchy. The caches may be DRAM based and much larger (on the order of larger than 1 GB) than state of the art caches (on the order of 32 MB).

### BRIEF SUMMARY

In summary, one aspect provides a method comprising: responsive to a request for data and a miss in both a first cache and a second cache, retrieving the data from memory, the first cache storing at least a subset of data stored in the second cache; inferring from information pertaining to the first cache a replacement entry in the second cache; and responsive to inferring from information pertaining to the first cache a replacement entry in the second cache, replacing an entry in the second cache with the data from memory.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example method of lightweight primary cache replacement using an associated cache.

FIG. 2 illustrates an example tag cache and an example primary cache.

FIG. 3 illustrates an example computer system.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of example embodiments of the invention. One skilled in the relevant art may well recognize, however, that embodiments may be practiced without at least one of the specific details thereof, or can be practiced with other methods, components, materials, et cetera. In other instances, well-known structures, materials, or operations are not shown or described in detail to avoid obfuscation.

It should be noted that the flowchart and block diagrams in the figures illustrate the architecture, functionality, and operation of possible implementations of systems, apparatuses, methods and computer program products according to various embodiments. In this regard, each block in the flowchart or block diagrams may represent a module, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As described herein, increased capacity memory subsystems have introduced a new level of cache into the memory hierarchy. The increased capacity memory hierarchy includes larger caches (e.g., on the order of larger than 1 GB) implemented as off-chip memory devices, referred to herein as a “primary cache” or “second cache” (e.g., a form of RAM memory used as a cache). Larger primary caches bring additional challenges, e.g., quickly determining if data is resident therein.

On-chip caching of address tags (“tags”) corresponding to entries in a cache has been implemented with the purpose of reducing chip area and providing faster access to frequently accessed data. Tag caches (or “first caches”) are maintained on “on-chip”, i.e. the faster memory, and may be used to quickly determine if requested data is stored in the slower primary cache (i.e., the data resides in the primary cache). Thus, a tag cache on chip (e.g., storing a subset of tags for a cache) may be quickly utilized to determine if data resides in the cache. In the event of a tag cache miss, the full cache directory (which is often stored on-chip as well) may be searched. In the event of a miss in response to searching the cache directory, the data may be retrieved from memory (e.g., main memory) and placed into the primary cache.

In response to a miss in response to searching a cache directory, (e.g., data unable to be located in a cache directory) the data retrieved from memory will be stored in the primary cache. The decision as to which line in the primary cache to replace has conventionally been governed by a replacement policy, e.g., a least recently used (LRU) cache line may be replaced. This requires storing LRU information (or whatever policy information), and this has conventionally been implemented by storing the LRU information in the primary cache.

However, this requires additionally space for the replacement policy information (e.g., LRU information) in the primary cache. Moreover, if the primary cache directory is stored on-chip, it must be updated to correspond to the replacement action. This in turn requires utilization of system resources (e.g., communication between the off-chip memory and the chip over a memory bus) to accomplish the same.

Tag cache implementation has therefore been mostly proposed for direct mapped primary cache designs as opposed to associative or set-associative designs. The tag cache extension to set-associative primary cache typically assumes one tag cached per position in a set-associative primary cache. For a 4-way set-associative primary cache, four tag caches are maintained, i.e., one for each bank, and maintenance of a global tag cache introduces substantial overhead. LRU bits in the tag cache have been used for replacement decisions in the tag cache on a tag miss, which can be a hit or miss in the primary cache, and both of which require replacement in the tag cache.

LRU bits in the primary cache have been used for replacement decisions on a primary cache miss, but for large caches with high-associative caches, LRU bits can be a significant overhead. Large cache implementations require large tag areas. For example, in an 8 GB 8-way primary cache with 128 B line size, the number of LRU bits required is three per set entry, and with 2̂23 sets in total this amounts to (2̂23)*24˜bits, or about 192 MB of space. Also, at each access to a set, the LRU positions need to be sorted. Thus very large last level (primary) caches are mostly proposed as direct mapped caches with additional techniques to reduce conflict misses, e.g., victim caches and address space randomization.

Accordingly, embodiments provide for a light weight cache replacement policy by utilizing replacement policy information of an associated, higher-level cache. In an embodiment, replacement policy information (e.g., LRU information) of a higher level cache (e.g., tag cache) is used to make replacement decisions in a lower level cache (e.g., off-chip primary cache). Because replacement policy information of the associated cache is utilized, the primary cache need not store replacement policy information (e.g., LRU information for primary cache lines). Moreover, this lowers the overhead involved in primary cache maintenance, e.g., reduced communication traffic for primary cache maintenance, as the replacement policy information is stored on-chip rather than in the primary cache (off-chip). Moreover, embodiments do not require any dependence of tag cache size and/or associativity on the primary cache size and/or associativity. Embodiments therefore intelligently employ tag cache information in replacement policy decisions in the primary cache, as earlier implementations of tag caches have not exploited any replacement policy information (e.g., LRU information) available from the tag cache to make replacement decisions in the primary cache.

The illustrated example embodiments will be best understood by reference to the figures. The following description is intended only by way of example, and simply illustrates certain example embodiments.

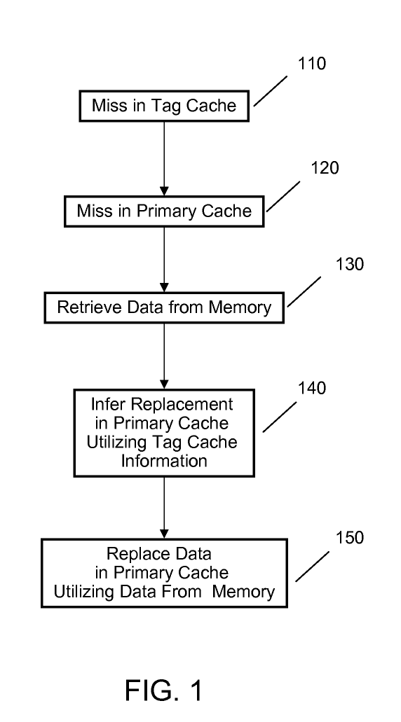

Referring now to FIG. 1, a high level overview of an example method for primary cache replacement is illustrated. On a request for data a tag cache may be first checked, and on a tag cache miss at 110, a primary cache may be checked. If a miss occurs in the primary cache as well at 120, the data will be retrieved from memory at 130. In the primary cache, the data retrieved from memory will be stored/cached, which may require other data to be removed. Conventionally, a replacement policy for the primary cache leverages replacement information (e.g., LRU bits) stored in the primary cache for making such a decision.

According to an embodiment, however, replacement policy information is not stored in the primary cache. Instead, replacement information is inferred, e.g., using information pertaining to the tag cache contents. Thus, given the existence of a tag cache, an embodiment infers the replacement decision there-from at 140. The replacement decision may be inferred from tag cache information in a variety of ways, as further described herein. At 150, the data inferred to be replaced is removed from the primary cache to allow storing of the data retrieved from memory.

Regarding how replacement is inferred for the primary cache using an associated cache (e.g., tag cache), some general principles apply. If an entry is in the tag cache then it is not a LRU entry in primary cache, unless all the entries of primary cache set are in the tag cache (i.e., a one to one mapping situation). Thus, absence of an entry in the tag cache may itself be used to infer a set of possible replacement lines in the primary cache. Thus, if out of Y entries of a set in primary cache p are also in tag cache, those p are among the top p ranked MRU (Most Recently Used) entries. The remaining Y-p entries can be all candidates for replacement.

Alternatively, if all Y entries of a set in primary cache are in the tag cache, and if all are in same the tag cache, LRU bits of the tag cache may be used to find LRU ordering among those entries and inferentially an LRU candidate in the primary cache. If all entries of a set in the primary cache are in the tag cache and they are dispersed across different tag sets, say 4, then: the entries mapping to the set in primary cache are identified; in each of those 4 sets, LRU ordering of those entries is obtained; and the LRU entry from each of the 4 sets is taken, and each of these is a candidate for replacement in the primary cache.

The following example cases illustrate some of these general principles for inferring replacement policy information for a primary cache using an associated cache. In these examples, an example system in which a tag cache of size “T” and associativity “X” is used by way of example, and a main/primary cache of size “S” and associativity “Y” is used by way of example. In the following example cases, suppose address “A” is a miss in both the tag cache and the primary cache and needs to be placed in the primary cache. Let address A map to set “S_k” in the primary cache.

Example Case 1: Associativity of the tag cache is smaller than the associativity of the sets in the primary cache (X<Y). Two special cases of Case 1 are examined below.

Example Case 1.1: The number of sets in the tag cache is larger than number of sets in main cache (T>S). Entries in the primary cache map to more than one set in the tag cache. Each primary cache set maps to Y/X sets in the tag cache. An embodiment examines the entries of the Y/X sets in the tag cache to which the primary cache (Sₖ)) entries map. An embodiment identifies the entries in each of these Y/X sets in the tag cache which are also present in Sₖ . Let eᵢ, i=1, . . . , Y/X, be the number of entries in the ith set (out of Y/X sets in tag cache to which Sₖ maps) which are also present in the primary cache. Observe that eᵢ for any i can take values from 0 to X. If Σᵢeᵢ<Y−1, an embodiment will do a random replacement between Y−Σᵢeᵢ entries of Sₖ. If Σᵢeᵢ=Y−1, an embodiment replaces the entry which is in Sₖ but not in any of the Y/X sets in tag cache. If Σᵢeᵢ=Y, an embodiment finds the LRU entry among the entries that map to Sₖ for each of the Y/X sets in tag cache and does a random replacement among that subset.

Example Case 1.2: The number of sets in the tag cache is smaller than number of sets in primary cache (T<S). The entries in the primary cache map can only map to one set in tag cache in this case. Let address A map to set Tₘ in tag cache. An embodiment examines the entries of the corresponding set in the tag cache. Let there be p tags in Tₘ that map to Sₖ (with p=0,1, . . . X). An embodiment does a random replacement between the Y−p entries of Sₖ.

Example Case 2: The associativity of the tag cache is larger than associativity of main cache (X>Y).

For Example Case 2 the only case of interest in when T<S as for the case when T>S, the total number of entries that tag cache can hold will be larger than the total number of entries that the primary cache can hold and hence the primary cache will be entirely contained in the tag cache. Let there be p tags in Tₘ that map to Sₖ (with p=0,1, . . . Y). If p<Y−1, an embodiment does a random replacement between Y−p entries of Sₖ. If p=Y−1, an embodiment replaces the entry not in Tₘ but in Sₖ. If p=Y, an embodiment replaces the entry with the lowest LRU bit in Tₘ among the entries mapping to Sₖ.

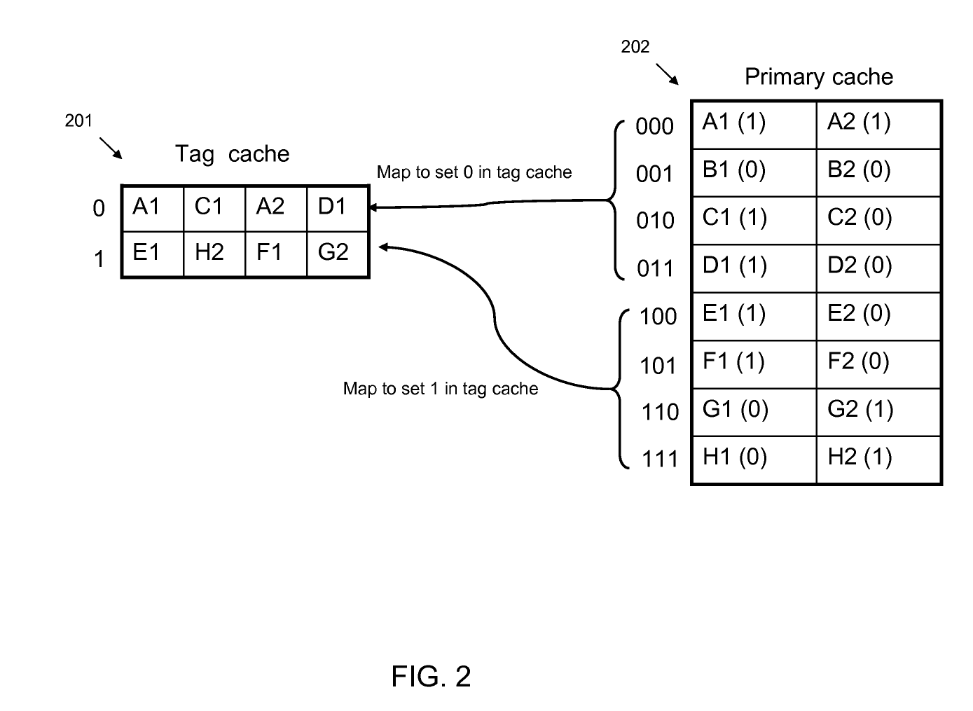

Turning now to FIG. 2, example implementations are illustrated as described. In FIG. 2 an example illustration of a 4-way associative tag cache 201 and a 2-way associative primary cache 202 is illustrated. This is simply an example operating environment and the general principles described herein may be extended to different operating environments.

In FIG. 2, illustrated is an implementation of maintaining a 1 bit/entry in primary cache 202 as a tag tracking bit (TTB). In the illustrated examples of FIG. 2, if TTB=1, this indicates that the entry is present in the tag cache 201. If the TTB=0, the entry is not present in the tag cache 201.

Referring to FIG. 2, example cases are used for illustrating aspects of an embodiment. If an address “A3” is requested and it maps to set 000 in the primary cache 202 and maps to 0 in the tag cache 201, on a miss in both the tag cache 201 and the primary cache 202, one entry in 000 of the primary cache 202 will be replaced. In the primary cache 202, both A1 and A2 TTB bits are set (present in the tag cache 201), so an embodiment looks at LRU position information of the tag cache 201. LRU information is stored left to right in the tag cache in the figure (right entry being less recently used compared with the left entry), although this is only for ease of illustration and description and this information may be retained, compiled and accessed in alternative ways. An embodiment replaces A2 in the primary cache 202 with A3, and sets the TTB=1. An embodiment replaces A2 in the tag cache 201 with A3, and updates the LRU in the tag cache 201.

In a second example, address B3 is requested and maps to set 001 in the primary cache 202 and 0 in the tag cache 201. On a miss in both the tag cache 201 and the primary cache 202, an embodiment determines that for both B1 and B2, the TTB is reset (i.e., TTB=0). An embodiment thus will replace randomly either B1 or B2 with B3, and set the corresponding TTB (TTB=1). In the tag cache 201, an embodiment replaces D1 (the LRU position in set 0 in tag cache 201) with B3, and updates the LRU in the tag cache 201.

With further reference to FIG. 2 a third example is described. Address C3 is requested and maps to set 010 in the primary cache 202 and 0 in the tag cache 201. On a miss in both the tag cache 201 and the primary cache 202, an embodiment determines that C1 has TTB set (TTB=1) and C2's TTB is reset (TTB=0), and thus an embodiment determines that C1 is the MRU. An embodiment replaces C2 in the primary cache 202 with C3 and sets the TTB=1 for C3. An embodiment replaces D1 in the tag cache 201 with C3, updating the LRU information in the tag cache 201.

As described herein, bits savings in a primary cache (off-chip cache) is a secondary benefit of the various embodiments. For example, in an 8-way associative primary cache with 4096 sets and 128 byte line size with 50 bit address space per cache entry there are 31 tag bits and 3 LRU bits. Since its 8-way cache, the total bits per set is thus 34*8=272 and the total bits over all sets is 272*4096=1114112.

In a first example of bits savings (“solution 1”), for a tag cache only, consider a tag cache having 8-way associativity, 512 sets and 128 B line size. Experiments have shown that a ⅛- 1/16 sized tag cache can achieve 95% hits. When the tag cache size is ⅛^{th} of the primary cache size, then the tag bits stored in the tag cache will be 3 bits larger than the tag bits in the primary cache. Taking the ⅛th size tag cache as an example, tag bits+LRU bits+offset bit (pointing to position in the primary cache set) per set entry equals 34+3+3. The total number of bits required per set in tag cache is (34+6)*8=320. The total bits in the tag cache=320*512=163480. The total bits in the primary cache is 1114112. Total bits thus equals the total bits in tag cache+total bits in primary cache, in this example 163840+1114112=1277952.

According to an embodiment, LRU bit maintenance at the primary cache is not necessary, as described herein, although an embodiment uses a 1 bit per entry in primary set (i.e., a TTB bit). The number of bits required on the tag cache is same as solution 1. The number of bits required on the primary cache per cache entry is 31 tag bits, 1 TTB, and the total bits per set is 32*8=256. The total bits over all sets is then 256*4096=1048576. Total bits is thus equal to the total bits in the tag cache+the total bits in the primary cache, or 163840+1048576=1212416. The total savings compared with solution 1 is 1277952−1212416=65536 bits. Thus the embodiment offers a saving of roughly 5% along with reducing communication during replacement between off-chip primary cache and on-chip tag cache due to the use of TTB bits.

Accordingly, embodiments offer bit savings in the primary cache and reduce communication between the primary cache (off chip cache) and the on chip memory elements due to replacement policy decision making Thus, the various example embodiments described herein allow for inferring replacement policy decisions in a primary cache without the need to maintain replacement policy information within the primary cache, but instead leveraging the available information in an associated cache (e.g., on-chip tag cache).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

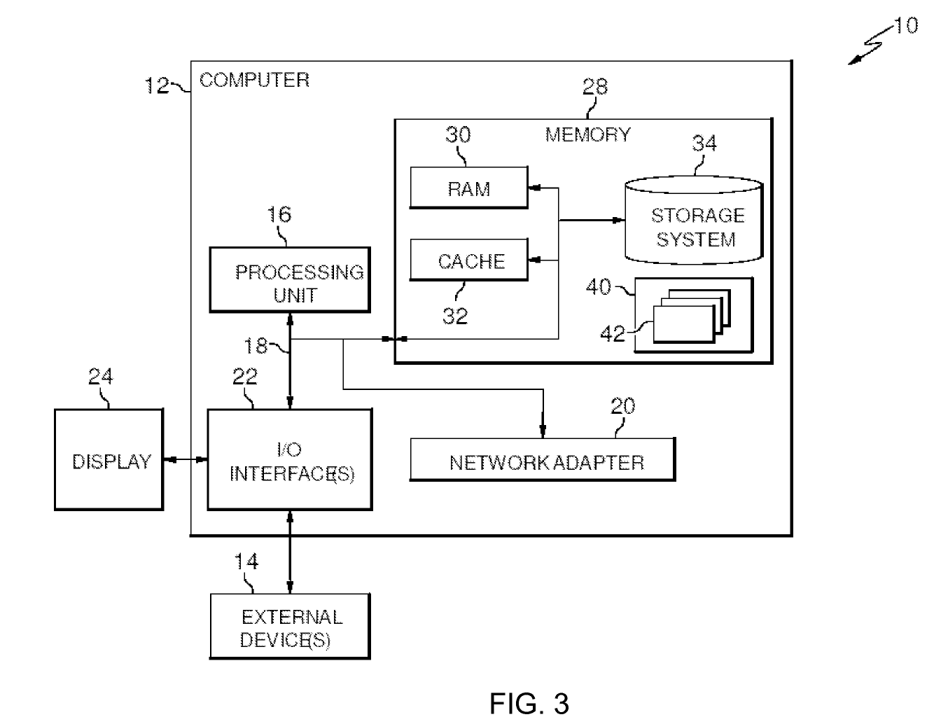

Referring now to FIG. 3, a schematic of an example of a computer system or other information handling device or data processing apparatus is shown. Computer system 10 is only one example of a suitable operating environment and is not intended to suggest any limitation as to the scope of use or functionality of embodiments of the invention described herein. Regardless, computer system 10 is capable of being implemented and/or performing any of the functionality set forth hereinabove.

In computer system 10 there is a computer 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or information handling devices, and the like.

Computer 12 may be described in the general context of computer system executable instructions, such as program modules, being executed by a computer system. Generally, program modules may include routines, programs, objects, components, logic, data structures, and so on that perform particular tasks or implement particular abstract data types.

As shown in FIG. 3, computer 12 is shown in the form of a general-purpose computing device. The components of computer system/server 12 may include, but are not limited to, one or more processors or processing units 16, which may include one or more caches on-chip, for example one or more tag caches as described herein (not shown in FIG. 5), a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer 12 typically includes a variety of computer system readable media. Such media may be any available media that is accessible by computer 12, and it includes both volatile and non-volatile media, removable and non-removable media.

System memory 28 can include computer system readable media in the form of volatile memory, such as random access memory (RAM) 30 and/or cache memory 32, which may itself include a larger cache memory devices (e.g., SDRAM used as a primary cache, as described herein). Computer 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer 12 may also communicate with one or more external devices 14 such as a keyboard, a pointing device, a display 24, etc.; one or more devices that enable a user to interact with computer 12; and/or any devices (e.g., network card, modem, etc.) that enable computer 12 to communicate with one or more other computing devices. Such communication can occur via Input/Output (I/O) interfaces 22. Still yet, computer 12 can communicate with one or more networks such as a local area network (LAN), a general wide area network (WAN), and/or a public network (e.g., the Internet) via network adapter 20. As depicted, network adapter 20 communicates with the other components of computer 12 via bus 18. It should be understood that although not shown, other hardware and/or software components could be used in conjunction with computer 12. Examples, include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure.

Although illustrative example embodiments have been described herein with reference to the accompanying drawings, it is to be understood that the embodiments are not limited to those precise examples, and that various other changes and modifications may be affected therein by one skilled in the art without departing from the scope or spirit of the disclosure.

What is claimed is:

1. An apparatus comprising:
at least one processor; and
a computer readable storage medium having computer readable program code embodied therewith and executable by the at least one processor, the computer readable program code comprising:
computer readable program code configured to, responsive to a request for data and a miss in both a first cache and a second cache, retrieve the data from memory, the first cache storing at least a subset of data stored in the second cache;
computer readable program code configured to infer from information available from the first cache a replacement entry in the second cache; and
computer readable program code configured to, responsive to inferring from information available from the first cache a replacement entry in the second cache, replace an entry in the second cache with the data from memory.

2. The apparatus of claim 1, wherein the first cache is a tag cache.

3. The apparatus of claim 2, wherein the second cache is a primary cache.

4. The apparatus of claim 3, wherein the primary cache is an off-chip cache.

5. The apparatus of claim 1, wherein the information pertaining to the first cache is stored in the second cache.

6. The apparatus of claim 5, wherein the information pertaining to the first cache is stored in the second cache as a tag tracking bit.

7. The apparatus of claim 6, wherein at least one tag tracking bit is stored per entry in the second cache.

8. The apparatus of claim 1, wherein the information pertaining to the first cache is least recently used information regarding one or more entries in the tag cache.

9. The apparatus of claim 1, wherein:
the information pertaining to the first cache indicates an entry is not present in the tag cache; and
further comprising computer readable program code configured to select the entry not present in the tag cache for replacement in the second cache with the data from memory.

10. The apparatus of claim 9, further comprising computer readable program code configured to:
responsive to replacing the entry in the primary cache not present in the tag cache, update the tag cache with the entry; and
update the least recently used information of the tag cache.

11. A computer program product comprising:
a computer readable storage medium having computer readable program code embodied therewith, the computer readable program code comprising:
computer readable program code configured to, responsive to a request for data and a miss in both a first cache and a second cache, retrieve the data from memory, the first cache storing at least a subset of data stored in the second cache;
computer readable program code configured to infer from information available from the first cache a replacement entry in the second cache; and
computer readable program code configured to, responsive to inferring from information available from the first cache a replacement entry in the second cache, replace an entry in the second cache with the data from memory.
